(19) United States
(12) Patent Application Publication
(10) Pub. No.: US 2026/0016329 A1
(43) Pub. Date: Jan. 15, 2026

(54) Device With At Least One Energy Storage

(71) Applicant: Osakeyhtiö SKF Aktiebolag, Espoo (FI)

(72) Inventor: Rauno Uolevi VEHMAA, Muram (FI)

(21) Appl. No.: 19/262,214

(22) Filed: Jul. 8, 2025

(30) Foreign Application Priority Data
Jul. 15, 2024 (DE) 102024206636.2

(51) Int. Cl. G01F 23/14

(52) U.S. Cl. CPC G01F 23/14

(57) ABSTRACT

A device (10) with at least one energy storage (12) has at least one indicator element (14). The indicator element (14) is mechanically connected to the energy storage. The indicator element (14) indicates in at least one operating state at least one information about a position of at least one region (16) of the energy storage.

### CROSS-REFERENCE TO RELATED APPLICATION

This application claims priority to German Application No. 102024206636.2, filed Jul. 15, 2024, the entirety of which is hereby incorporated by reference.

### FIELD

The present disclosure concerns a device with at least one energy storage.

### BACKGROUND

Known is a transparent cartridge. Through the cartridge a follower piston can be seen. Moreover, cartridge level indication with electrical sensors is known. This technique needs electrical power. Furthermore, cartridge level indication by using magnets was described in the past. This technique requires a complicated construction.

### SUMMARY

The problem address by the present disclosure is in particular to provide an indication with a simple construction, which can be applied in a wide range of situations. The problem is solved according to the present disclosure by the features of claim 1, while advantageous embodiments of the present disclosure can be taken from the subclaims.

The present disclosure proceeds from a device with at least one energy storage.

It is proposed that the device comprises at least one indicator element, which is mechanically connected to the energy storage and which indicates in at least one operating state at least one information about a position of at least one region of the energy storage. Through this an indication with a simple construction, which can be applied in a wide range of situations, can be achieved.

With advantage the device comprises at least one receptacle, in which at least a part of the energy storage is located, and at least a part of the indicator element indicates in the operating state the at least one information, wherein the part is located in the operating state outside of the receptacle. Thereby a good visibility of the part can be reached and the receptacle can be lightproof.

Furthermore, it is suggested that at least a part of the receptacle is lightproof. Through this the receptacle can be made from a robust and cost-efficient material. In particular, at least a part of the receptacle, which has a mass, which is bigger than fifty percent by weight of a total mass of the receptacle, can be lightproof. Especially the complete receptacle can be lightproof.

Advantageously the energy storage is a spring. Through this a simple construction can be achieved. In particular, the energy storage can be a coil spring.

Moreover, it is suggested that the indicator element is fixed to the spring. Through this a simple mechanism of an indication of the indicator element can be reached.

Furthermore, it is proposed that the spring is a coil spring, which at least partially consists of wire, wherein the indicator element is fixed to a first sector of the wire and at least to a second sector of the wire and between the first sector and the second sector is a third sector of the wire, which comprises a surface, which is free from any direct contact to a fixation to the indicator element. Thereby a movement of the indicator element with a small amount of friction during an operating procedure can be achieved.

With advantage the third sector is a part of the coil spring which is sized between a quarter of a turn of the coil spring and three quarters of a turn of the coil spring. Through this a movement of the indicator element with a very small amount of friction during the operating procedure can be achieved.

Moreover, it is suggested that the spring comprises a first end and a second end and the second end exerts a force on a piston of the device in the operating state and is located opposite to the first end, wherein the indicator element has a distance from the second end in the operating state, which is larger than three quarters of a length of the spring in the operating state. Thereby a small length of the indicator element can be reached. In particular, a cost-efficient construction of the indicator element can be achieved.

Advantageously the spring is linear. A spring is linear if it obeys Hooke's Law and has only one spring constant. Through this it is easily possible to infer a length change of the complete spring from knowing only a length change of one or a few turns of the spring.

With advantage the indicator element and at least one fixation element, which is a part of the device and which fixes the indicator element to the energy storage, are formed integrally. Thereby a simple construction can be achieved.

Furthermore, it is proposed that the indicator element is a pin. Through this a cost efficient and effective design of the indicator element is reached.

In particular, the device can comprise a fluid. In particular, the device can comprise a reservoir. In particular, the fluid can be at least partially located in the reservoir.

### BRIEF DESCRIPTION OF THE DRAWINGS

Further advantages can be seen in the following description of the drawings. An example of an embodiment of the present disclosure is shown in the drawings. The drawings, the description and the claims contain numerous features in combination. The skilled person will expediently also consider the features individually and combine them to form useful further combinations.

FIG. 1 shows a partial axial section of a device according to the present disclosure in an operating state,

FIG. 2 shows a partial axial section of the device in a state, in which a reservoir of the device is empty, and

FIG. 3 shows a partial axial section through the device in a state without the reservoir.

### DETAILED DESCRIPTION

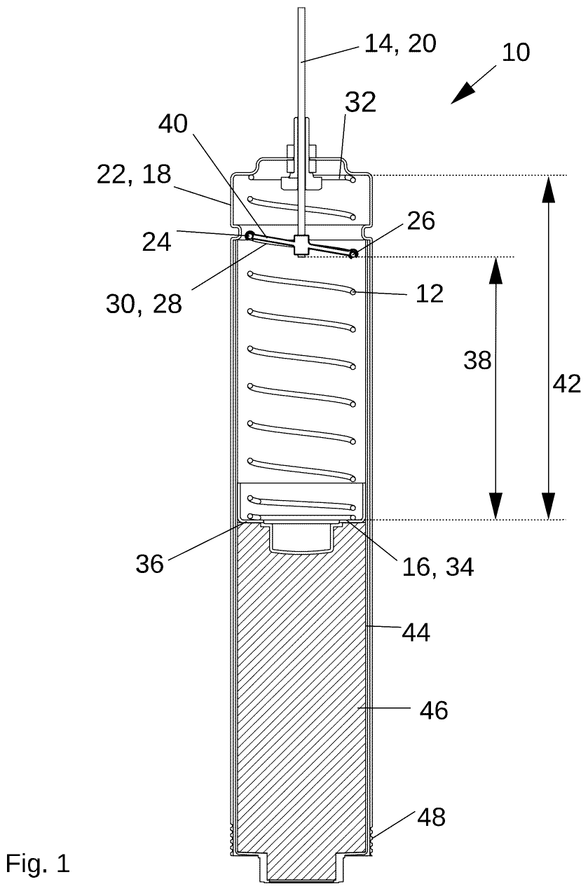

FIG. 1 shows a partial axial section of a device 10 according to the present disclosure in an operating state. The device 10 comprises an energy storage 12, which is a pressure spring. In the embodiment of FIG. 1 the spring is a linear coil spring and consists of wire. Moreover, the device comprises an indicator element 14, which is fixed to the spring and which is a pin.

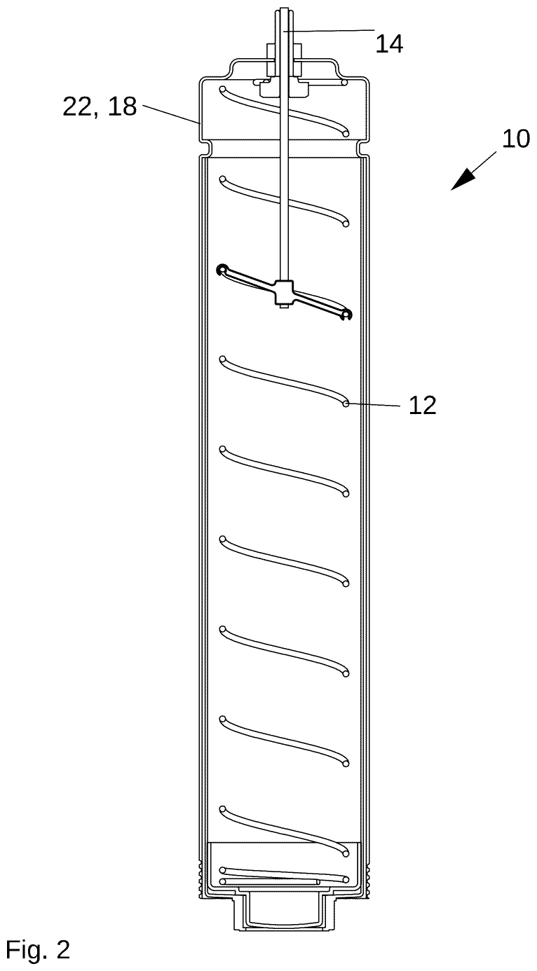

The indicator element 14 indicates in the operating state information about a position of a region 16 of the energy storage. The region 16 is a second end 34 of the spring, which is located opposite to a first end 32 of the spring. The indicator element 14 is fixed to a first sector 24 of the wire and to a second sector 26 of the wire through a fixation element 40 of the device. The fixation element 40 has the shape of a pin. The indicator element 14 is fixed with one of its ends to the middle of the fixation element 40. One end of the fixation element is fixed to the first sector and a second end of the fixation element is fixed to the second sector. Each of the indicator element and the fixation element is one part. Alternatively, the indicator element and the fixation element are formed integrally. Between the first sector and the second sector is a third sector 28 of the wire, which is half a turn of the coil spring. A surface 30 of the third sector is free from any direct contact to a fixation to the indicator element 14. A point of the fixation element, at which the indicator element is fixed, has a first distance from the first end 32 in the operating state. In the operating state the spring has a certain length 42. The length 42 can be calculated by multiplying the first distance with the length of the spring in a state in the device, in which the spring is maximally extended, divided by the distance of the point of the fixation element from the first end 32 in the state of the device, in which the spring is maximally extended (FIG. 2). Therefore, the position of the indicator element 14 is an indication of the position of the second end 34. The position of the second end 34 is an indication of a filling level of a fluid reservoir 44 of the device with a fluid 46. The fluid can be grease. The reservoir is a cartridge. When the reservoir is full of the fluid, the spring is maximally compressed. In this state the longitudinal direction of the indicator element 14 and the longitudinal direction of the fixation element 40 are arranged perpendicular relative to each other. When the spring expands starting from this state, deformations of the indicator element and the fixation element take place until the device arrives at some point in time in the operating state (FIG. 1). Then the longitudinal direction of the indicator element and the longitudinal direction of the fixation element are not perpendicular to each other any more but are slant relative to each other.

The device 10 comprises a receptacle 18, in which the energy storage 12 is located. In the state of the device, in which the spring is maximally extended (FIG. 2), only a small part of the indicator element 14 protrudes from the receptacle. In the operating state a further part 20 of the indicator element protrudes from the receptacle and is located outside of the receptacle. The length of this part 20 indicates the position of the second end 34 in the operating state and visualized the filling level.

The first end 32 is located opposite to the second end 34 and abuts against an end region of the receptacle. Moreover, the second end 34 of the spring exerts a force on a piston 36 of the device 10 in the operating state and abuts against the piston. The piston is located inside of the reservoir in the operating state and exerts a force on the fluid 46. The indicator element 14 has a distance 38 from the second end 34 in the operating state, which is larger than three quarters of a length 42 of the spring in the operating state. When the spring expands, it presses the fluid out of the reservoir and out of the receptacle.

In the operating state the receptacle is screwed with the help of a thread 48 to a pump (not shown). The reservoir is screwed to the pump with its own thread.

A part 22 of the receptacle is lightproof. In fact, the complete receptacle is lightproof in the embodiment of FIG. 1. The receptacle can be made from metal.

When the spring is maximally extended (FIG. 2), the reservoir is empty. The position of the indicator element in this case indicates that the reservoir has to be filled or changed.

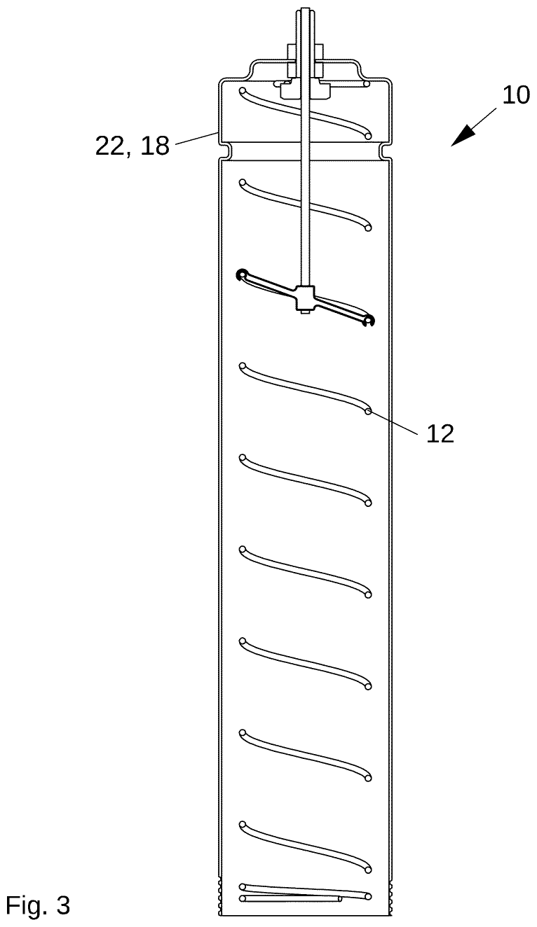

FIG. 3 shows a partial axial section through the device in a state without the reservoir.

In total the indication by the indicator element is simple and reliable for all kinds of reservoirs and cartridges which have a follower mechanism to cartridge level indication.

The indicator pin and the fixation element are made from bendable plastic, for example Polyethylene terephthalate glycol.

The device can be used to not only measure but to also to monitor the movement of the spring in a fraction of the length of that of the spring.

The present disclosure can be used in all shapes and sizes of reservoir covers and in other applications with springs of different sizes and variations.

The reservoir can be assembled to the receptacle and can be disassembled from the receptacle without destroying anything. If the reservoir doesn't contain any fluid (FIG. 2), it can easily be replaced by a new reservoir, which is full of fluid.

### LIST OF REFERENCE NUMERALS

10 device
12 energy storage
14 indicator element
16 region
18 receptacle
20 part
22 part
24 sector
26 sector
28 sector
30 surface
32 end
34 end
36 piston
38 distance
40 fixation element
42 length
44 reservoir
46 fluid
48 thread

What is claimed is:

1. A device comprising:
an energy storage; and
an indicator element mechanically connected to the energy storage, the indicator element configured to indicate in an operating state at least one information about a position of at least one region of the energy storage.

2. The device according to claim 1, further comprising a receptacle, at least a part of the energy storage is located in the receptacle, and the indicator element having a part configured to indicate in the operating state the at least one information, wherein said part of the indicator element is located in the operating state outside of the receptacle.

3. The device according to claim 2, wherein at least a part of the receptacle is lightproof.

4. The device according to claim 1, wherein the energy storage is a spring.

5. The device according to claim 4, wherein the indicator element is fixed to the spring.

6. The device according to claim 5, wherein the spring is a coil spring comprising a wire, wherein the indicator element is fixed to a first sector of the wire and at least to a second sector of the wire, between the first sector of wire and the second sector of wire is a third sector of the wire, the third sector of wire comprising a surface which is free from any direct contact to a fixation to the indicator element.

7. The device according to claim 4, further comprising a piston, wherein the spring comprises a first end and a second end opposite the first end, the second end exerting a force on the piston in the operating state, wherein the indicator element has a distance from the second end in the operating state that is larger than three quarters of a length of the spring in the operating state.

8. The device according to claim 4, wherein the spring is linear.

9. The device according to claim 1, further comprising a fixation element fixing the indicator element to the energy storage, the fixation element and the indicator element being formed integrally.

10. The device according to claim 1, wherein the indicator element is a pin.

11. The device according to claim 3, wherein the energy storage is a spring.

12. The device according to claim 11, wherein the indicator element is fixed to the spring.

13. The device according to claim 12, wherein the spring is a coil spring comprising a wire, wherein the indicator element is fixed to a first sector of the wire and at least to a second sector of the wire, between the first sector of wire and the second sector of wire is a third sector of the wire, the third sector of wire comprising a surface which is free from any direct contact to a fixation to the indicator element.

14. The device according to claim 13, further comprising a piston, wherein the spring comprises a first end and a second end opposite the first end, the second end exerting a force on the piston in the operating state, wherein the indicator element has a distance from the second end in the operating state that is larger than three quarters of a length of the spring in the operating state.

15. The device according to claim 14, wherein the spring is linear.

16. The device according to claim 15, further comprising a fixation element fixing the indicator element to the energy storage, the fixation element and the indicator element being formed integrally.

17. The device according to claim 16, wherein the indicator element is a pin.
